(19) United States
(12) Patent Application Publication
(10) Pub. No.: US 2007/0087592 A1
(43) Pub. Date: Apr. 19, 2007

(54) Two circuit board housing integrated interconnect

(75) Inventors: Kenneth S. Thomson, Huntsville, AL (US); Karl W. Laue, Taft, TN (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/580,600

(22) Filed: Oct. 13, 2006

Related U.S. Application Data
(60) Provisional application No. 60/727,984, filed on Oct. 14, 2005.

(51) Int. Cl. H01R 12/00

(52) U.S. Cl. 439/78

(57) ABSTRACT

An electrical device includes terminals encased within a housing and having distal ends connectable to two different circuit boards to provide a reliable electrical connection between the circuit boards. The first circuit board and the second circuit board are electrically connected through terminals that are embedded within the housing. Openings within the two circuit boards provide for electrical communication and continuity between the two circuit boards by a mating interference fit with the terminals. The electric contact provided by the interference fit between the terminal and the opening is dependable through extreme temperature ranges.

### CROSS REFERENCE TO RELATED APPLICATION

The application claims priority to U.S. Provisional Application No. 60/727,984 which was filed on Oct. 14, 2005.

### BACKGROUND OF THE INVENTION

This invention generally relates to a circuit board connection. More particularly, this invention relates to an electrical connection between at least two circuit boards.

Electronic devices and components are becoming smaller and smaller. The reduced size allotted for electronic devices has required increased use of multiple circuit boards. Multiple circuit boards can be positioned in stacks that require less space and provide for a more compact electronic package and device. A requirement that stems from the use of multiple circuit boards is the need for reliable electrical connections between the multiple circuit boards. Further, such electrical connections are required to withstand temperature swings and extreme vibrations.

Conventional connection methods include the use of ribbon or flexible circuits that are attached to each printed circuit board. Other conventional methods include the use of a connector plug and mating receptacle. Such conventional methods take up valuable circuit board space, and provide less then desirable dependability.

Accordingly, it is desirable to design and develop a method and device that provides the desired electrical connection that requires little space and that provides the desired durability.

### SUMMARY OF THE INVENTION

An example electrical device includes terminals encased within a housing with distal ends connectable to different circuit boards to provide a reliable electrical connection between the circuit boards.

The example electronic device includes a housing that supports a first circuit board and a second circuit board. The first circuit board and the second circuit board are electrically connected through terminals that are embedded within the housing.

Each of the circuit boards includes openings. The openings provide for electrical communication and continuity between the two circuit boards by a mating interference fit with the terminals. The terminals are held firmly and securely within the housing such that assembly of the circuit boards is accomplished by assembling the terminals into corresponding openings, of the circuit boards. The electric contact provided by the interference fit between the terminal and the opening is dependable through extreme temperature ranges.

Accordingly, the example terminals provide a positive reliable electrical connection between two circuit boards without complex and expensive connectors and manufacturing steps. Further, the example electrical device provides for integration of terminals to the housing to provide reliable manufacturing and electrical connectivity between two circuit boards.

These and other features of the present invention can be best understood from the following specification and drawings, the following of which is a brief description.

### BRIEF DESCRIPTION OF THE DRAWINGS

FIG. 1 is an exploded view of an example electric device.

FIG. 2 is a sectioned view of the example electric device.

FIG. 3 is a cross-sectional view of an example terminal disposed within an example housing of the electric device.

FIG. 4 is a plane view of an example strip of terminals.

FIG. 5 is a cross-sectional view of example terminals within a terminal block.

FIG. 6 is a cross-sectional view of another example terminal.

FIG. 7 is a cut-away view of another example terminal.

FIG. 8 is a side cross-sectional view the example terminal of FIG. 7.

FIG. 9 is a top view of an example terminal block.

FIG. 10 is an enlarged view of an example interface between terminal halves.

### DETAILED DESCRIPTION OF THE PREFERRED EMBODIMENT

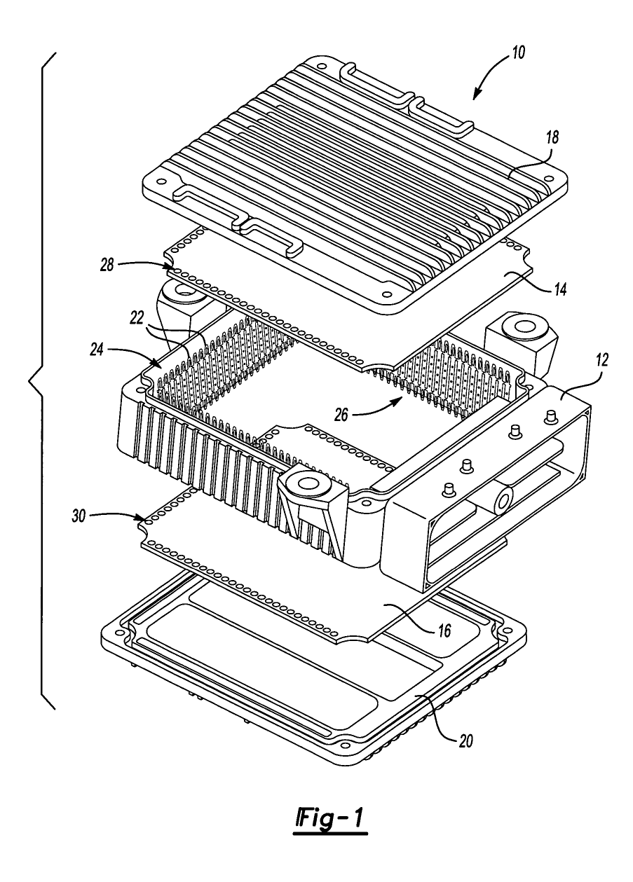

Referring to FIG. 1, an example electronic device 10 includes a housing 12 that supports a first circuit board 14 and a second circuit board 16. The first circuit board 14 and the second circuit board 16 are electrically connected through terminals 22 that are embedded within the housing 12. A first cover 18 and a second cover 20 attach to the housing 12 to cover and protect the circuit boards 14, and 16 and any electrical components mounted on those circuit boards 14, 16. The circuit boards 14, 16 are shown without components for clarity, however, each circuit board 14, 16 will support a number of circuit components as are required for the desired application.

Each of the circuit boards 14, 16 include openings 28, 30. The openings 28, 30 provide for electrical communication and continuity between the two circuit boards 14, 16 by a mating interference fit with the terminals 22. Each of the terminals 22 includes a first end 24 that is received within the opening 28 of the first circuit board. The terminals 22 also include a second end 26 that is received within the corresponding opening 30 disposed within the second circuit board 16. The terminals 22 are held firmly and securely within the housing 12 such that assembly of the circuit boards 14, 16 is accomplished by assembling the terminals 22 into corresponding openings 28, 30 of the circuit boards.

The example housing 12 is substantially square shaped and includes rows of terminals 22 disposed on each side. The number of terminals 22 disposed on each side provides the desired electrical communication between the two circuit boards 14, 16. The example housing 12 also includes features for attaching the covers 18, 20. The example housing 12 also includes an attachment configuration for a connector and other accessory items that are desired to communicate information to the circuitry assembled to the circuit boards 14, 16. Although the example housing 12 is square shaped, a worker with the benefit of this disclosure would understand how to configure the housing and number of terminals for specific applications.

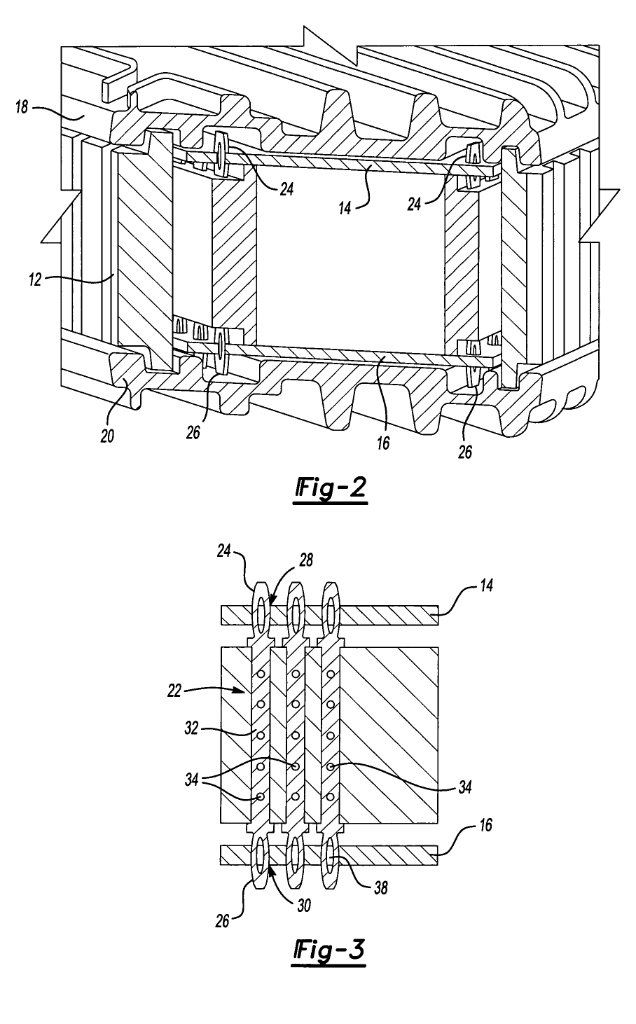

Referring to FIG. 2, a cut-away corner of the electrical device 10 is shown. Each of the terminals 22 extends from the first end 24 to the second end 26. The terminals 22 are insert molded within the housing 12 by way of known process. The terminal 22 thereby is held within the housing 12 in a desired position to provide the desired connectivity between circuit boards 14, 16.

The first end 24 of the terminal 22 is received within the opening 28 of the first circuit board 14. The interference fit between the first end of the terminal and the opening 28 provides a desired electrical contact. The electric contact provided by the interference fit between the terminal 22 and the opening 28 is dependable through extreme temperature ranges. The first end 24 and the second end 26 of the terminal are substantial duplicates and provide the same desired interference fit that makes the electrical connection dependable.

Referring to FIG. 3, the terminals 22 include the body portion 32 that extends between the first end 24 and the second end 26. The body portion 32 includes openings 34 that provide for the securement of the terminals 22 within the housing 12. The example housing 12 is formed from a plastic material that flows through the openings 34 in the terminals 22. Upon solidification of the housing material, the plastic within the openings 34 provides for the rigid securement of the terminals within the housing 12.

The ends 24, 26 of the terminals include an eyelet 38. The eyelet 38 provides for the limited expansion and contraction of the terminal ends 24, 26 to compensate for temperature fluctuations and the relative expansion and contraction between the terminals 22 and the circuit boards 14, 16.

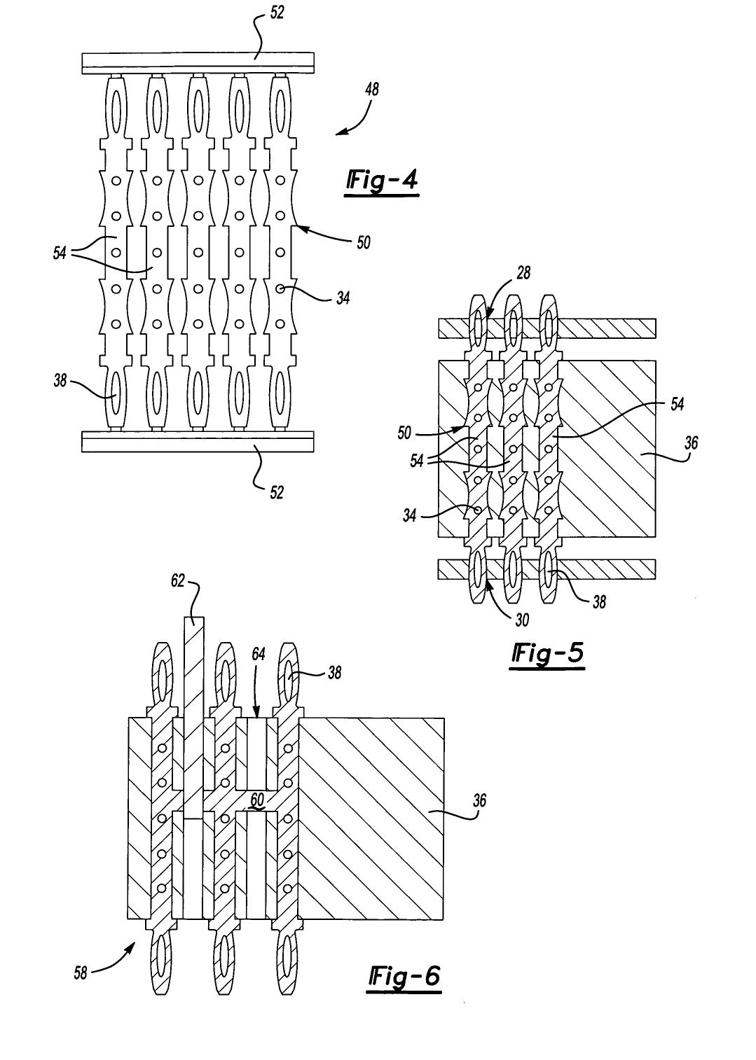

Referring to FIG. 4, an example terminal strip 48 is supported between carrier strips 52. The carrier strips 52 provide for the placement and spacing of adjacent terminals 54. The example terminals 52 include securement features including a tab 50. The tabs 50 provide for the locking of the individual terminals 54 in the housing or other plastic encasement.

The example terminal strip 48 is spaced apart a distance that corresponds to openings within the circuit boards 14, 16. The spacing can be altered or modified to accommodate application specific requirements. The terminals 54 are fabricated through known stamping process to provide the desired configuration. The carrier strips 52 remain part of the terminals during processing and assembly. The carrier strips 52 aids in handling and processing through the overmolding process. Once the terminals are mounted as desired, the carrier strips 52 are removed. The interface between the carrier strips 52 and the corresponding terminals provides for simple separation.

Referring to FIG. 5, the terminals 54 are integrally molded within a terminal block 36. Instead of being molded within a larger housing assembly, the terminals may be encapsulated within a terminal block 36 for discrete assembly and placement. In this way, multiple terminal blocks 36 can be assembled to provide the desired spacing between circuit boards 28, 30 without the constraining the terminals to an outer perimeter of a housing. The number of terminals 54 disposed within a terminal block can vary to provide the desired electrical connectivity between circuit boards 28, 30.

Referring to FIG. 6, another example terminal strip 58 includes a carrier strip 60 disposed in a middle portion of the terminals 66. The example terminal block 36 includes openings 64 disposed between adjacent terminals 66. The terminals 66 are secured within the terminal block 36 by an overmolding process. The terminal strip 58 is placed within a mold including the carrier strip 60. The carrier strip 60 holds the desired spacing between adjacent terminals 66 throughout the overmolding process. Once overmolding is complete, a punch 62 is driven through the openings 64 to sever the connection between adjacent terminals 66. Once the terminals 66 are severed, each will provide separate electrical connection path between circuit boards. Alternatively, desired portions of the carrier strip may be left intact to provide for desired electrical communication between more than one corresponding and adjacent terminal 66.

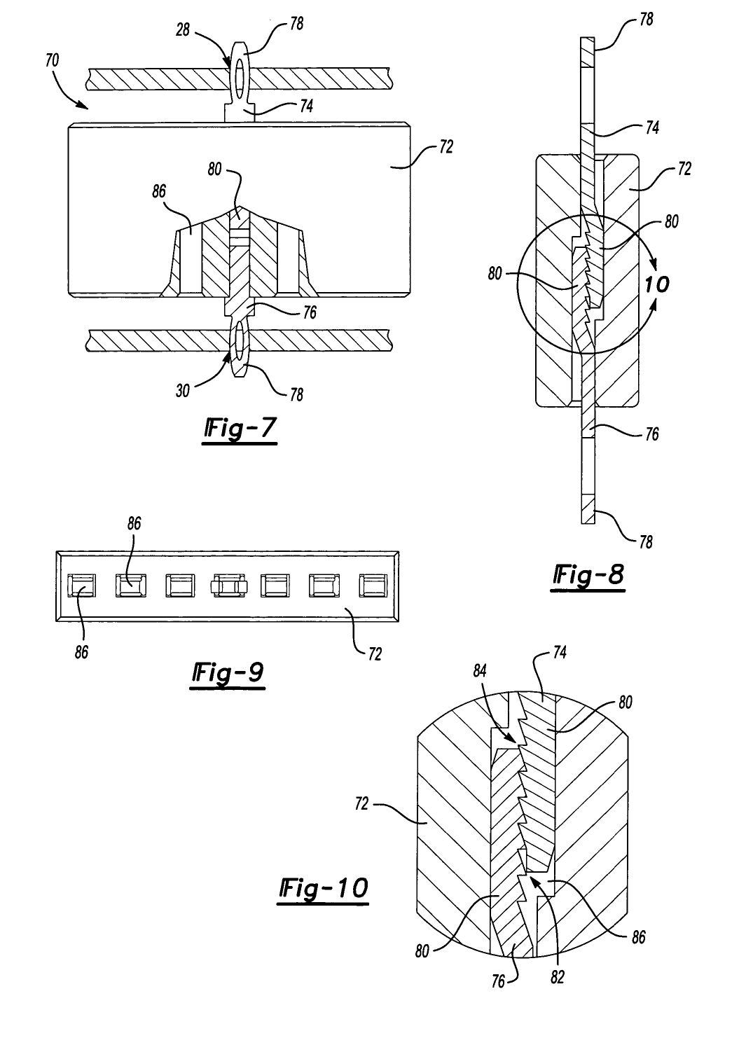

Referring to FIGS. 7-10, an example terminal assembly 70 includes a housing or block 72 that supports terminals for electrically connecting two circuit boards. The example terminals include a first half 74 and a second half 76. Each of the first half and the second half 74, 76 are identical and assembled into the block 72 from opposite ends. The block 72 is fabricated from a non-conductive material such as plastic and includes openings 86 (FIG. 9).

The terminal halves 74, 76 include a first end 78 that is received within an opening within the circuit boards 28, 30. The first ends 78 provide the desired interference that provides the desired electrical connection. The second end 80 of the terminals halves 74, 76 comprises a plurality of interlocking teeth 84. The teeth 84 engage each other to provide an interface 82 between the two halves 74, 76 within the opening 86 of the terminal block 72. The interlocking teeth 84 of each terminal half 74, 76 drive the second ends outward into interference contact with the inner surfaces of the opening 86. The interference contact maintains the desired electrical connection between terminal halves 74 and 76 and holds the terminals within the terminal block 72. The opening 86 includes an offset region that provides sufficient space for the adjacent terminal halves 74 and 76 to make electrical contact and interlock the teeth 84.

Accordingly, the example terminals provide a positive reliable electrical connection between two circuit boards without complex and expensive connectors and manufacturing steps. Further, the example electrical device provides for integration of terminals to the housing to provide reliable manufacturing and electrical connectivity between two circuit boards.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A circuit board assembly comprising:
a first circuit board including a first opening;
a second circuit board including a second opening; and
a terminal including a first end received within the first opening, and a second end received within the second opening.

2. The circuit board assembly as recited in claim 1, wherein an interface between the first end of the terminal and the first opening and the second end of the terminal and the second opening comprises an interference fit.

3. The circuit board assembly as recited in claim 1, including housing for supporting the first circuit board and the second circuit board, wherein the terminal is at least partially encased within the housing.

4. The circuit board assembly as recited in claim 1, including a plurality of terminals, and a corresponding plurality of first openings within the first circuit board, and a corresponding plurality of second openings within the second circuit board.

5. The circuit board assembly as recited in claim 1, wherein the terminal comprises a single uninterrupted part from the first end extending to the second end.

6. The circuit board assembly as recited in claim 1, including a plurality of terminals supported within a terminal block with the first end and the second end extending from the terminal block.

7. The circuit board assembly as recited in claim 1, including a terminal block, wherein each of the terminals comprise a first terminal half and a second terminal half each insertable into the terminal block.

8. The circuit board assembly as recited in claim 7, wherein the first terminal half interlocks the second terminal half within the terminal blocks to provide an electrical connection therebetween.

9. An electronic device comprising:
a housing including a first side and a second side;
a plurality of terminals disposed within the housing, wherein each of the plurality of terminals includes a first end extending from the first side of the housing, and a second end extending from the second side of the housing;
a first circuit board including a plurality of first openings corresponding with the first end of the plurality of terminals, wherein the first end of the plurality of terminals are received within the corresponding plurality of first openings; and
a second circuit board including a plurality of second openings corresponding with the second end of the terminals, wherein the second end of the plurality of terminals is received within the corresponding plurality of second openings.

10. The electronic device as recited in claim 9, wherein an interface between the first end and the second of each of the plurality of terminals and the corresponding plurality of first and second openings comprises interference fit.

11. The electronic device as recited in claim 9, wherein the plurality of terminals are molded within the housing.

12. The electronic device as recited in claim 9, wherein the housing includes a plurality of holes corresponding to the plurality of terminals and each of the terminals comprise a first half inserted from the first side and second half inserted from the second side, where the first half and the second half interconnect to create an electrical connection.

13. The electronic device as recited in claim 12, wherein each of the first and second halves include a connection end including a plurality of teeth that interlocks with corresponding teeth on the other of the first and second halves.

14. The electronic device as recited in claim 9, wherein each of the plurality of terminals includes retention features for maintaining terminal position within the housing.
